(19) United States
(12) Patent Application Publication
(10) Pub. No.: US 2024/0158612 A1
(43) Pub. Date: May 16, 2024

(54) THERMOPLASTIC POLYAMIDE PARTICLES FOR TOUGHENING COMPOSITE MATERIALS

(71) Applicant: Cytec Industries Inc., Princeton, NJ (US)

(72) Inventors: Marie-Laure Michon, Villeurbanne (FR); Hazel-Ann Hosein, Anaheim, CA (US); Pierre-Yves Lahary, Lyon (FR); Alexandra Argoud, La Chapelle-De-La-Tour (FR); William Jacobs, Bethel, CT (US); Vincent Aerts, Chester (GB)

(73) Assignee: Cytec Industries Inc., Princeton, NJ (US)

(21) Appl. No.: 18/548,871

(22) PCT Filed: Feb. 28, 2022
(86) PCT No.: PCT/EP2022/055017

§ 371 Date: Sep. 1, 2023

Related U.S. Application Data
(60) Provisional application No. 63/154,937, filed on Mar. 1, 2021.

(30) Foreign Application Priority Data
Apr. 27, 2021 (EP) 21305540.3

(51) Int. Cl. C08K 5/20; C08G 69/28

(52) U.S. Cl. CPC C08K 5/20; C08G 69/28

(57) ABSTRACT

The present disclosure relates to thermoplastic copolyamide particles for toughening and/or reducing microcracking in composite materials, wherein the particles have a given particle distribution.

### CROSS REFERENCE TO RELATED APPLICATIONS

This applications claims priority to U.S. provisional patent application No. 63/154,937, filed on Mar. 1, 2021, and to European patent application number 21305540.3, filed on Apr. 27, 2021, both of which are incorporated herein by reference in their entirety for all purposes.

### FIELD OF THE INVENTION

The present invention generally relates to thermoplastic polyamide particles for toughening composite materials. More specifically, the present invention relates to thermoplastic polyamide copolymer particles for toughening composite materials, wherein the particles have a given particle distribution.

### BACKGROUND

Fiber-Reinforced Polymer (“FRP”) composites are promoted as the modern replacement material for more traditional materials in a variety of applications, including in the aerospace, automotive, marine, industrial, and infrastructure/building fields. Specifically, FRP composites can be used to replace metals and alloys, such as steel and aluminum, as well as concrete depending on the application field.

The push for FRP composites can be attributed to a variety of factors such as the desire for metal replacement alternatives, as well as light-weight materials having a balance of desired properties that can include toughness and chemical resistance. More specifically, maintaining or even increasing the desired properties for FRP composites, while at the same time reducing the overall weight, eliminating the issues associated with metal fatigue and corrosion, thus allowing for the production of aerospace aircrafts, automotive and transport vehicles, and marine vessels, and parts thereof, that have better fuel economy without sacrificing performance of the same. Further, by manufacturing parts and components for aircrafts, vehicles, and vessels using FRP composites, not only can the overall weight of the aircrafts, vehicles, and vessels be reduced, but the time required to make and machine the parts and components can be reduced. Similarly, with respect to construction and infrastructure applications, FRP composites can offer alternatives to traditional building and construction materials, while reducing the overall cost, weight (and associated stresses and loads) of the structure, and time needed construct (i.e., through prefabrication processes) and maintain the same.

In order to produce FRP composites, fibers pre-impregnated with a matrix resin (“prepreg”) can be used. In particular, a prepreg can be placed into a mold, or multiple prepregs can be layered into a mold, and then cured in the mold at a given temperature and pressure to form the end FRP composite. Yet, even with using the prepregs, the resulting FRP composites can lack the desired strength and toughness for certain applications, especially for aerospace applications.

With a temperature change in a composite part, such as FRP composites, it expands or contracts in different directions depending on its coefficient of thermal expansion (CTE), which depends on the orientation of the plies. With an independent and stress-free ply, expansion or contraction occurs with caution, and no stress is produced, regardless of the orientation of the ply. But when the plies are turned in different orientations and laminated together, each ply will not be able to expand or contract according to its own CTE due to the stress of adjacent plies. This results in high stresses in the plies. As the matrix has a lower in situ failure stress than the fiber, microcracks are created in the matrix. Microcracking can lead to profound changes in properties, such as rigidity. A composite part, when subjected to thermal cycles and humid periods, undergoes contraction and expansion stress and microcracks may develop.

Accordingly, there remains a need in the art for toughening and/or reducing microcracking in composite materials, including FRP composites. Further, and more particularly, there remains a need in the art for toughening and/or reducing microcracking in composite materials, including FRP composites, for aerospace, automotive, marine, and infrastructure/building applications.

### SUMMARY OF THE INVENTION

In a first aspect, the present disclosure relates to a collection of thermoplastic copolyamide particles comprising:
a particle distribution D90 of 100 μm or less, typically 65 μm or less, more typically 50 μm or less, and wherein the copolyamide comprises recurring units RPA1 and RPA2 or RPA3 and RPA2, wherein RPA1 is represented by the structure

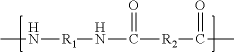

RPA2 is represented by the structure

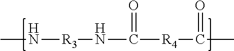

RPA3 is represented by the structure

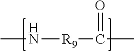

wherein
R₁ is a C₂-C₁₈ aliphatic group, typically C₂-C₁₈ alkylene group;
R₂ is a C₂-C₁₆ aliphatic group, typically C₂-C₁₆ alkylene group;
R₃ is selected from the group consisting of C₂-C₁₈ alkylene groups, C₆-C₁₈ arylene groups, and C₅-C₁₈ cycloaliphatic groups;
R₄ is selected from the group consisting of C₂-C₁₆ alkylene groups, C₆-C₁₈ arylene groups and C₅-C₁₈ cycloaliphatic groups; and
R₉ is a C₅-C₁₄ alkylene;
wherein the collection of copolyamide particles comprises:
   a glass transition temperature of no more than 100° C.; and
   a melting enthalpy peak temperature and a crystallization enthalpy peak temperature, each as determined by modulated differential scanning calorimetry during the first heating of a sample of such dry copolymer, wherein melting enthalpy peak temperature is from 150 to 260° C. and the difference between the crystallization enthalpy peak temperature and the melting enthalpy peak temperature is less than or equal to 30° C.

In a second aspect, the present disclosure relates to a process for making thermoplastic polyamide copolymer particles, the process comprising:
reacting (a) at least one C₆-C₁₆ cycloaliphatic diamine, typically at least one C₈-C₁₂ cycloaliphatic diamine, (b) at least one C₆-C₁₀ linear or branched aliphatic diamine, typically at least one C₆-C₈ linear or branched aliphatic diamine, and (c) at least one C₁₀-C₁₄ linear or branched aliphatic dicarboxylic acid, typically at least one C₁₀-C₁₂ linear or branched aliphatic dicarboxylic acid, or
reacting (a′) at least one C₆-C₁₆ cycloaliphatic diamine, typically at least one C₈-C₁₂ cycloaliphatic diamine, (b′) at least one dicarboxylic acid, and (c′) at least one C₆-C₁₅ amino acid or C₆-C₁₅ lactam to form the thermoplastic polyamide copolymer, and
processing the thermoplastic polyamide copolymer into the form of particles,
wherein the particles comprise a particle distribution D90 of 100 μm or less, typically 65 μm or less, more typically 50 μm or less.

In a third aspect, the present disclosure relates to a composite material comprising: the collection of thermoplastic copolyamide particles described herein or the thermoplastic copolyamide particles made according to the process described herein; reinforcing fibers and a matrix resin.

In a fourth aspect, the present disclosure relates to a composite article produced from the composite material described herein.

### DETAILED DESCRIPTION

As used herein, the terms “a”, “an”, or “the” means “one or more” or “at least one” and may be used interchangeably, unless otherwise stated.

As used herein, the term “and/or” used in a phrase in the form of “A and/or B” means A alone, B alone, or A and B together.

As used herein, the term “comprises” includes “consists essentially of” and “consists of.” The term “comprising” includes “consisting essentially of” and “consisting of.” “Comprising”, which is synonymous with “including,” “containing,” or “characterized by,” is intended to be inclusive or open-ended and does not exclude additional, unrecited elements or steps. The transitional phrase “consisting essentially of” is inclusive of the specified materials or steps and those that do not materially affect the basic characteristic or function of the composition, process, method, or article of manufacture described. The transitional phrase “consisting of” excludes any element, step, or component not specified.

Unless defined otherwise, all technical and scientific terms used herein have the same meaning as is commonly understood by one of skill in the art to which this specification pertains.

As used herein, and unless otherwise indicated, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 50%, 20%, 15%, 10%, 9%, 8%, 7%, 6%, 5%, 4%, 3%, 2%, 1%, 0.5%, or 0.05% of a given value or range.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

The term and phrases “invention,” “present invention,” “instant invention,” and similar terms and phrases as used herein are non-limiting and are not intended to limit the present subject matter to any single embodiment, but rather encompasses all possible embodiments as described.

It should be noted that in specifying any range of concentration, weight ratio or amount, any particular upper concentration, weight ratio or amount can be associated with any particular lower concentration, weight ratio or amount, respectively.

As used herein, the terminology “(Cₙ-Cₘ)” in reference to an organic group, wherein n and m are each integers, indicates that the group may contain from n carbon atoms to m carbon atoms per group.

As used herein in reference to an organic compound, the term “aliphatic” means that the organic compound has a straight or branched chain structure and lacks any aryl or alicyclic ring moiety, wherein the chains comprise carbon atoms joined by respective single, double, or triple bonds and may optionally be interrupted by one or more heteroatoms, typically selected from oxygen, nitrogen, and sulfur heteroatoms, and the carbon atom members of the chains may each optionally be substituted with one or more organic groups that lack any aryl or alicyclic ring moiety, typically selected from alkyl, alkoxyl, hydroxyalkyl, cycloalkyl, alkoxyalkyl, haloalkyl.

As used herein in reference to an organic compound, the term “alicyclic” means that the compound comprises one or more non-aromatic ring moieties and lacks any aryl ring moiety, wherein the members of the one or more non-aromatic ring moieties comprise carbon atoms, each of the one or more non-aromatic ring moieties may optionally be interrupted by one or more heteroatoms, typically selected from oxygen, nitrogen, and sulfur heteroatoms, and the carbon atom members of the one or more non-aromatic ring moieties may each optionally be substituted with one or more non-aryl organic groups, typically selected from alkyl, alkoxyl, hydroxyalkyl, cycloalkyl, alkoxyalkyl, haloalkyl.

As used herein, the term “alkenyl” means an unsaturated straight, branched, or cyclic hydrocarbon radical, more typically an unsaturated straight, branched, or cyclic (C₂-C₂₂) hydrocarbon radical, that contains one or more carbon-carbon double bonds, such as, for example, ethenyl, n-propenyl, iso-propenyl, and cyclopentenyl.

As used herein, the term “alkoxy” means a saturated straight or branched alkyl ether radical, more typically a (C₁-C₂₂) alkyl ether radical , such as, for example, methoxy, ethoxy, n-propoxy, isopropoxy, n-butoxy, tert-butoxy, sec-butoxy, n-pentoxy, and nonoxy.

As used herein, the term “alkoxyalkyl” means an alkyl radical that is substituted with one or more alkoxy substituents, more typically a (C₁-C₂₂) alkyloxy (C₁-C₆) alkyl radical, such as methoxymethyl, and ethoxybutyl.

As used herein, the term “alkyl” means a monovalent straight or branched saturated hydrocarbon radical, more typically, a monovalent straight or branched saturated (C₁-C₂₂) hydrocarbon radical, such as, for example, methyl, ethyl, n-propyl, isopropyl, n-butyl, isobutyl, tert-butyl, n-hexyl, n-octyl, and n-hexadecyl.

As used herein, the term “alkynyl” refers to an unsaturated straight or branched hydrocarbon radical, more typically an unsaturated straight or branched (C₂-C₂₂) hydrocarbon radical that has one or more carbon-carbon triple bonds per radical such as, for example, ethynyl, and propargyl.

As used herein, the term “aralkyl” means an alkyl group substituted with one or more aryl groups, more typically a (C₁-C₁₈) alkyl substituted with one or more (C₆-C₁₄) aryl substituents, such as, for example, phenylmethyl, phenylethyl, and triphenylmethyl.

As used herein in reference to an organic compound, the term “aromatic” means that the organic compound that comprises one or more one aryl moieties, which may each optionally be interrupted by one or more heteroatoms, typically selected from oxygen, nitrogen, and sulfur heteroatoms, and one or more of the carbon atoms of one or more one aryl moieties may optionally be substituted with one or more organic groups, typically selected from alkyl, alkoxyl, hydroxyalkyl, cycloalkyl, alkoxyalkyl, haloalkyl, aryl, alkaryl, aralkyl.

As used herein, the term “aryl” means cyclic, coplanar 5- or 6-membered organic group having a delocalized, conjugated π system, with a number of π electrons that is equal to 4n+2, where n is 0 or a positive integer, including compounds where each of the ring members is a carbon atom, such as benzene, compounds where one or more of the ring members is a heteroatom, typically selected from oxygen, nitrogen and sulfur atoms, such as furan, pyridine, imidazole, and thiophene, and fused ring systems, such as naphthalene, anthracene, and fluorene, wherein one or more of the ring carbons may be substituted with one or more organic groups, typically selected from alkyl, alkoxyl, hydoxyalkyl, cycloalkyl, alkoxyalkyl, haloalkyl, aryl, alkaryl, halo groups, such as, for example, phenyl, methylphenyl, trimethylphenyl, nonylphenyl, chlorophenyl, or trichloromethylphenyl.

As used herein, the term “cycloalkenyl” refers to cyclic (C₅-C₂₂) alkenyl radical having a single cyclic ring and at least carbon-carbon double bond between ring carbons, which can be optionally substituted with from 1 to 3 alkyl groups, such as, for example, cyclopent-3-enyl, cyclohex-2-enyl, and cyclooct-3-enyl.

As used herein, the term “cycloalkyl” means a saturated (C₅-C₂₂) hydrocarbon radical that includes one or more cyclic alkyl rings, such as, for example, cyclopentyl, cyclooctyl, and adamantanyl.

As used herein, “epoxide group” means a vicinal epoxy group, i.e., a 1,2-epoxy group.

The substituent groups described herein may be bivalent, i.e., two hydrogen atoms may be replaced by chemical bonds. Such substituent groups are often modified by an “-ene” ending herein. For example, the term “alkylene” means an alkyl radical with an additional hydrogen replaced by a chemical bond. Similarly, the term “arylene” means an aryl radical with an additional hydrogen replaced by a chemical bond.

In the first aspect, the present disclosure relates to a collection of thermoplastic copolyamide particles comprising:
a particle distribution D90 of 100 μm or less, typically 65 μm or less, more typically 50 μm or less, and wherein the copolyamide comprises recurring units RPA1 and RPA2 or RPA3 and RPA2, wherein RPA1 is represented by the structure

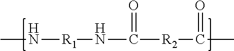

RPA2 is represented by the structure

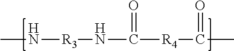

RPA3 is represented by the structure

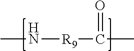

wherein
R₁ is a C₂-C₁₈ aliphatic group, typically C₂-C₁₈ alkylene group;
R₂ is a C₂-C₁₆ aliphatic group, typically C₂-C₁₆ alkylene group;
R₃ is selected from the group consisting of C₂-C₁₈ alkylene groups, C₆-C₁₈ arylene groups, and C₅-C₁₈ cycloaliphatic groups;
R₄ is selected from the group consisting of C₂-C₁₆ alkylene groups, C₆-C₁₈ arylene groups and C₅-C₁₈ cycloaliphatic groups; and
R₉ is a C₅-C₁₄ alkylene;
wherein the collection of copolyamide particles comprises:
   a glass transition temperature of no more than 100° C.; and
   a melting enthalpy peak temperature and a crystallization enthalpy peak temperature, each as determined by modulated differential scanning calorimetry during the first heating of a sample of such dry copolymer, wherein melting enthalpy peak temperature is from 150 to 260° C. and the difference between the crystallization enthalpy peak temperature and the melting enthalpy peak temperature is less than or equal to 30° C.

As used herein, the phrase “collection of thermoplastic copolyamide particles” refers to a plurality of thermoplastic copolyamide particles sufficient for the presence of a particle distribution in accordance with the present disclosure, such as a particle distribution D90 of 100 μm or less, typically 65 μm or less, more typically 50 μm or less.

In some embodiments, one of R₃ and R₄ is an alkyl group and R₃ and R₄ are not both alkyl groups.

In an embodiment, either (a) R₃ is C₅-C₁₈ cycloaliphatic group and R₄ is a C₂-C₁₆ alkyl group or (b) R₃ is a C₂-C₁₈ alkyl group and R₄ is a C₅-C₁₈ cycloaliphatic group. Typically, R₃ is C₅-C₁₈ cycloaliphatic group and R₄ is a C₂-C₁₆ alkyl group.

Recurring unit RPA1 is formed from the polycondensation of a C₂-C₁₈ aliphatic diamine and a C₄-C₂₀ aliphatic dicarboxylic acid.

In an embodiment, the C₂-C₁₈ aliphatic diamine is represented by the following formula:

H₂N—R₁—NH₂

wherein R₁ is a C₂-C₁₈ alkylene group.

In some embodiments, the C₂-C₁₈ aliphatic diamine is represented by the following formula: H₂N—(C(R₅)(R₆))ₙ₁—NH₂, where R₅ and R₆, at each location, are independently selected alkyl groups and n1 is an integer from 2 to 18. In some such embodiments, R₅ and R₆, at each location, are H. Additionally or alternatively, in some embodiments, n1 is an integer from 4 to 16, from 4 to 12, from 4 to 10, or from 6 to 10. Typically, n1 is 6.

Examples of desirable C₂-C₁₈ aliphatic diamines include, but are not limited to, 1,2-diaminoethane, 1,2-diaminopropane, propylene-1,3-diamine, 1,3-diaminobutane, 1,4-diaminobutane, 1,5-diaminopentane, 2-methyl-1,5-diaminopentane, hexamethylenediamine (or 1,6-diaminohexane), 3-methylhexamethylenediamine, 2,5-dimethylhexamethylenediamine, 2,2,4-trimethyl-hexamethylenediamine, 2,4,4-trimethyl-hexamethylenediamine, 1,7-diaminoheptane, 1,8-diaminooctane, 2,2,7,7-tetramethyloctamethylenediamine, 1,9-diaminononane, 2-methyl-1,8-diaminooctane, 5-methyl-1,9-diaminononane, 1,10-diaminodecane, 1,11-diaminoundecane, 1,12-diaminododecane and 1,13-diaminotridecane. In an embodiment, the C₂-C₁₈ aliphatic diamine is hexamethylene diamine.

In an embodiment, the C₄-C₂₀ aliphatic dicarboxylic acid is represented by the following formula:

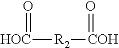

wherein R₂ is a C₂-C₁₆ alkylene group.

In some embodiments, the C₄-C₂₀ aliphatic dicarboxylic acid is represented by the following formula: (HO)(O═)C—(C(R₇)(R₈))ₙ₂—C(═O)(OH), where R₇ and R₈, at each location, are independently selected alkyl groups and n2 is an integer from 2 to 18. In some such embodiments, at each location, R₇ and R₈ are H. Additionally or alternatively, in some embodiments, n2 is an integer from 4 to 16, from 6 to 16, from 6 to 12 or from 8 to 12. Typically, n2 is 10.

Exemplary C₄-C₂₀ aliphatic dicarboxylic acids include, but are not limited to, malonic acid, succinic acid, glutaric acid, 2,2 dimethyl glutaric acid, adipic acid, 2,4,4 trimethyl-adipic acid, pimelic acid, suberic acid, azelaic acid, sebacic acid, undecanedioic acid, dodecandioic acid, tridecanedioic acid, tetradecanedioic acid, pentadecanedioic acid [HOOC—(CH₂)₁₃—COOH], hexadecanedioic acid, and octadecanedioic acid. In an embodiment, the C₄-C₂₀ aliphatic dicarboxylic acid is sebacic acid.

The recurring unit RPA2 is formed from the polycondensation of a diamine and dicarboxylic acid.

The diamine is selected from the group consisting of C₂-C₁₈ aliphatic diamines, C₆-C₁₈ aromatic diamines and C₅-C₁₈ cycloaliphatic diamines and the dicarboxylic acid selected from the group consisting of C₄-C₂₀ aliphatic dicarboxylic acid, C₈-C₂₀ aromatic dicarboxylic acids and C₇-C₂₀ cycloaliphatic dicarboxylic acids, typically with the proviso that the C₂-C₁₈ aliphatic diamines and C₄-C₂₀ aliphatic dicarboxylic acids are as described above with respect to recurring unit RPA1.

In an embodiment, the diamine is represented by the following formula:

H₂N—R₃—NH₂

wherein R₃ is selected from the group consisting of C₂-C₁₈ alkylene groups, C₆-C₁₈ arylene groups, and C₅-C₁₈ cycloaliphatic groups.

In some embodiments, the C₆-C₁₈ aromatic diamine is represented by the following formula: H₂N—Ar₁—NH₂, where Ar₁ is a C₆-C₁₈ aryl group. Examples of suitable C₆-C₁₈ aromatic diamines include, but are not limited to, m-phenylene diamine (“MPD”), p-phenylene diamine (“PPD”), 3,4′-diaminodiphenyl ether (3,4′ ODA), 4,4′-diaminodiphenyl ether (4,4′-ODA), p-xylylene diamine (“PXDA”) and m-xylylenediamine (“MXDA”).

In some embodiments, the C₅-C₁₈ cycloaliphatic diamine is represented by the following formula: H₂N-T₁-NH₂, where T₁ is a C₅-C₁₈ cycloaliphatic group. Examples of desirable C₅-C₁₈ cycloaliphatic diamines include, but are not limited to, isophorone diamine (3-aminomethyl-3,5,5-trimethylcyclohexylamine; “IPD”), 1,3-diaminocyclohexane, 4,4′-methlenebis(2-methylcyclohexyl-amine), 4,4′-methylenebis(cyclohexylamine), 1,4-diaminocyclohexane, bis-p-aminocyclohexylmethane, 1,3-bis(aminomethyl)cyclohexane, 1,4 bis(aminomethyl)cyclohexane, bis(4-amino-3-methylcyclohexyl) methane and bis(4-aminocyclohexyl)methane.

In an embodiment, the dicarboxylic acid is represented by the following formula:

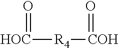

R₄ is selected from the group consisting of C₂-C₁₆ alkylene groups, C₆-C₁₈ arylene groups and C₅-C₁₈ cycloaliphatic groups.

In some embodiments, the C₈-C₂₀ aromatic dicarboxylic acid is represented by the following formula: (HO)(O═)C—Ar₂—C(═O)(OH), where Ar₂ is a C₆-C₁₈ aryl group. Examples of desirable C₈-C₂₀ aromatic dicarboxylic acids include, but are not limited to, isophthalic acid (“IA”), terephthalic acid (“TA”), naphthalenedicarboxylic acids (e.g. naphthalene-2,6-dicarboxylic acid), 4,4′ bibenzoic acid, 2,5-pyridinedicarboxylic acid, 2,4 pyridinedicarboxylic acid, 3,5-pyridinedicarboxylic acid, 2,2 bis(4 carboxyphenyl)propane, 2,2 bis(4 carboxyphenyl)hexafluoropropane, 2,2 bis(4 carboxyphenyl)ketone, 4,4′ bis(4-carboxyphenyl)sulfone, 2,2 bis(3-carboxyphenyl)propane, 2,2 bis(3-carboxyphenyl)hexafluoropropane, 2,2 bis(3 carboxyphenyl)ketone, and bis(3-carboxyphenoxy)benzene.

In some embodiments, the C₇-C₂₀ cycloaliphatic dicarboxylic acid is represented by the following formula: (HO)(O═)C-T₂-C(═O)(OH), where T₂ is a C₅-C₁₈ cycloaliphatic group. Examples of desirable C₇-C₂₀ cycloaliphatic dicarboxylic acids include, but are not limited to, 1,4-cyclohexane dicarboxylic acid (“CHDA”).

The recurring unit RPA3 is formed from the polycondensation of an amino acid or lactam. Typically, the amino acid has at least 6 carbon atoms, for example, from 6 to 15 carbon atoms or from 7 to 13 carbon atoms, in the aminocarboxylic acid backbone. Examples of desirable amino acids include, but are not limited to of 9-aminononanoic acid, 10-aminodecanoic acid, 11-aminoundecanoic acid, 12-aminododecanoic acid, 13-aminotridecanoic acid. Typically, the lactam has at least 6 carbon atoms in the lactam ring, for example, from 6 to 15 carbon atoms or from 7 to 13 carbon atoms, in the lactam ring. Examples of desirable lactams include, but are not limited to, caprolactam and laurolactam.

In an embodiment, the copolyamide copolymer comprises or consists of recurring units of at least one polycondensation product of:
at least one C₆-C₁₆ cycloaliphatic diamine, typically at least one C₈-C₁₂ cycloaliphatic diamine,
at least one C₆-C₁₀ linear or branched aliphatic diamine, typically at least one C₆-C₈ linear or branched aliphatic diamine, and
at least one C₁₀-C₁₄ linear or branched aliphatic dicarboxylic acid, typically at least one C₁₀-C₁₂ linear or branched aliphatic dicarboxylic acid; or
recurring units of at least one polycondensation product of:
at least one C₆-C₁₆ cycloaliphatic diamine, typically at least one C₈-C₁₂ cycloaliphatic diamine,
at least one dicarboxylic acid, and
at least one C₆-C₁₅ amino acid or C₆-C₁₅ lactam.

In some embodiments, the copolyamide comprises recurring units RPA1 and RPA2.

In an embodiment, the copolyamide copolymer comprises or consists of recurring units of at least one polycondensation product of:
at least one C₆-C₁₆ cycloaliphatic diamine, typically at least one C₈-C₁₂ cycloaliphatic diamine,
at least one C₆-C₁₀ linear or branched aliphatic diamine, typically at least one C₆-C₈ linear or branched aliphatic diamine, and
at least one C₁₀-C₁₄ linear or branched aliphatic dicarboxylic acid, typically at least one C₁₀-C₁₂ linear or branched aliphatic dicarboxylic acid.

In some embodiments, recurring unit RPA1 is formed from the polycondensation of hexamethylene diamine and sebacic acid. In some embodiments recurring unit RPA2 is formed from the polycondensation of IPD and sebacic acid.

In some embodiments, recurring unit RPA1 is formed from the polycondensation of hexamethylene diamine and sebacic acid and recurring unit RPA2 is formed from the polycondensation of IPD and sebacic acid. In some embodiments, the copolyamide comprises or consists of poly(hexamethylene sebacamide) and poly(isophorone sebacamide). In such embodiments, recurring units RPA1 and RPA2 are represented by the following formulae, respectively:

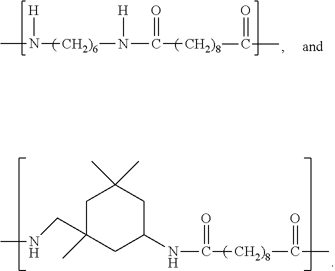

The total concentration of recurring units RPA1 and RPA2 is at least 51 mol %. As used herein, mol % is relative to the total number of moles of recurring units in the copolyamide, unless explicitly stated otherwise. In some embodiments, the total concentration of recurring units RPA1 and RPA2 is at least 60 mol %, at least 70 mol %, at least 80 mol %, at least 90 mol %, at least 95 mol %, at least 99 mol % or at least 99.5 mol %.

In some embodiments, the concentration of recurring unit RPA1 is at least 55 mol %, at least 60 mol %, at least 65 mol % or at least 70 mol %. In some embodiments, the concentration of recurring unit RPA1 is no more than 95 mol %. In some embodiments, the concentration of recurring unit RPA1 is from 55 mol % to 95 mol %, from 60 mol % to 95 mol % or from 70 mol % to 95 mol %. In some embodiments, the concentration of recurring unit RPA2 is at least 5 mol %. In some embodiments, the concentration of recurring unit RPA2 is no more than 45 mol %, no more than 40 mol %, no more than 35 mol % or no more than 30 mol %. In some embodiments, the concentration of recurring unit RPA2 is from 5 mol % to 45 mol %, from 5 mol % to 40 mol %, from 5 mol % to 35 mol % or from 5 mol % to 30 mol %.

In some embodiments, the relative molar concentration of recurring unit RPA1 to RPA2, i.e. [RPA1]/[RPA2], is at least 60/40, at least 70/30, at least 75/25, or at least 80/20. In some embodiments, [RPA1]/[RPA2] is no more than 90/10. In some embodiments, [RPA1]/[RPA2] is from 70/30 to 90/10, from 75/25 to 90/10 or from 80/20 to 90/10. Typically, the total concentration of recurring units RPA1 and RPA2 is at least 80 mol %, at least 90 mol %, at least 95 mol %, at least 98 mol %, at least 99 mol %, at least 99 mol % or at least 99.5 mol %.

In an embodiment, the relative molar concentration of recurring unit RPA1 to recurring unit RPA2 is at least 70/30. In an embodiment, [RPA1]/[RPA2] is 75/25.

In another embodiment, the copolyamide comprises:
70-95 mol. % of repeat units of formula:

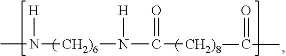

and
5-30 mol. % of repeat units of formula:

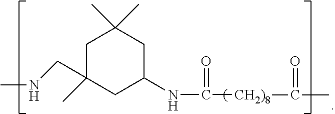

The copolyamide is a semi-crystalline polyamide. As used herein, a semi-crystalline polyamide has a heat of fusion (“ΔH_{f}”) of at least 5 joules per gram (“J/g”) at a heating rate of 20° C./min. OH_{f} can be measured according to ASTM D3418.

In some embodiments, the copolyamides have a glass transition temperature (“T_{g}”) of no more than 100° C. In some embodiments, the copolyamide has a T_{g} of at least 40° C. In some embodiments, the copolyamide has a T_{g} of no more than 90° C. or no more than 80° C. In some embodiments, the copolyamide has a Tg of from 40° C. to 100° C., from 40° C. to 90° C., from 40° C. to 80° C., or from 50° C. to 80° C. The T_{g} is obtained by differential scanning calorimetry (DSC). DSC is applied to the copolyamide in particulate form using instruments known to those of ordinary skill in the art, such as a Perkin Elmer 8000. Typically, approximately 10 mg of sample, typically in particle form, is placed in an aluminium cap that is then closed (not hermetically) with a lid. The sample is run under nitrogen flow (50 ml/min). After a stabilization step of 1 min at 40° C., a first heating ramp is applied at 10° C./min up to 270° C. followed by a stabilization step of 5 min at 270° C. A cooling ramp is then applied at 10° C./min up to 0° C. After 5 min at 0° C., a second heating ramp is applied at 10° C./min up to 270° C. The Tg is measured on the signal obtained during this second heating ramp at 10° C./min (Midpoint).

In some embodiments, the copolyamides have a melting temperature (“Tₘ”) of at least 150° C., at least 180° C., or at least 190° C. In some embodiments, the copolyamides have a Tₘ of no more than 260° C., no more than 250° C., no more than 240° C., no more than 230° C., no more than 220° C. or no more than 215° C. In some embodiments, the copolyamides have a Tₘ of from 180° C. to 260° C., from 190° C. to 250° C., from 190° C. to 240° C., from 190° C. to 230° C., from 190° C. to 220° C., from 190° C. to 215° C., from 195° C. to 260° C., from 195° C. to 250° C., from 195° C. to 240° C., from 195° C. to 230° C., from 195° C. to 220° C. or from 195° C. to 215° C. Tₘ is determined using modulated DSC, as described herein.

In some embodiments, the copolyamides have a crystallization temperature (“T_{c}”) of at least 120° C., at least 150° C., or at least 180° C. In some embodiments, the copolyamides have a T_{c} of no more than 260° C., no more than 250° C., no more than 240° C., no more than 230° C., no more than 220° C. or no more than 215° C. In some embodiments, the copolyamides have a T_{c} of from 150° C. to 260° C., from 190° C. to 250° C., from 190° C. to 240° C., from 190° C. to 230° C., from 190° C. to 220° C., from 190° C. to 215° C. Tc is measured with modulated DSC.

The Tₘ and T_{c} of the copolyamides and particles thereof are measured by modulated differential scanning calorimetry (MDSC) using instruments known to those of ordinary skill in the art. For example, a Q2000 machine available from TA Instrument would be suitable. For each measurement, approximately 10 mg of sample is added to an aluminium cap that is then closed (not hermetically) with a lid, then the sample is dried in the closed cap in a vacuum (typically <5 mbars) oven for 16 h at 90° C. The accurate weight is then measured after the drying step. The MDSC measurements are run using the Heat only mode under nitrogen flow (50 ml/min) immediately after the drying step or after being stored in a sealed bag to avoid moisture uptake. The measurements are done on a first heating ramp after an isothermal step of 5 min, applying the following conditions: equilibration at 35° C., modulation of +/−0.53° C. every 40 s, isothermal standing for 5 min, then application of a heating ramp of 5° C./min to 300° C. The signals of interest are the reversing heat flow and the non reversing heat flow. Crystallization behavior is observed as an exothermic peak. The melting is observed as an endothermic peak. The values of Tₘ and T_{c} are taken as the values at the maximum of the respective peaks.

The difference in Tₘ and T_{c}, i.e., Tₘ-T_{c}, of the copolyamides described herein is no more than 30° C. In some embodiments, copolyamides have a (Tₘ-T_{c}) of no more than 20° C., no more than 15° C. or no more than 10° C. In some embodiments, (Tₘ-T_{c}) is no less than 5° C. In some embodiments, (Tₘ-T_{c}) is from 5° C. to 30° C., from 5° C. to 20° C., from 5° C. to 15° C. or from 5° C. to 10° C. It was surprisingly found that the relatively small Tₘ-T_{c} values provided for particles that rendered composite materials containing them with decreased levels of cracking, particularly microcracking.

In some embodiments, the copolyamides have a number average molecular weight (“Mₙ”) of from 1,000 g/mol to 40,000 g/mol, for example from 2,000 g/mol to 35,000 g/mol, from 4,000 to 30,000 g/mol, or from 5,000 g/mol to 20,000 g/mol. Mₙ can be determined by gel permeation chromatography (“GPC”) according to ASTM D5296 with polystyrene standards.

In the second aspect, the present disclosure relates to a process for making thermoplastic polyamide copolymer particles, the process comprising:
reacting (a) at least one C₆-C₁₆ cycloaliphatic diamine, typically at least one C₈-C₁₂ cycloaliphatic diamine, (b) at least one C₆-C₁₀ linear or branched aliphatic diamine, typically at least one C₆-C₈ linear or branched aliphatic diamine, and (c) at least one C₁₀-C₁₄ linear or branched aliphatic dicarboxylic acid, typically at least one C₁₀-C₁₂ linear or branched aliphatic dicarboxylic acid, or
reacting (a′) at least one C₆-C₁₆ cycloaliphatic diamine, typically at least one C₈-C₁₂ cycloaliphatic diamine, (b′) at least one dicarboxylic acid, and (c′) at least one C₆-C₁₅ amino acid or C₆-C₁₅ lactam to form the thermoplastic polyamide copolymer, and
processing the thermoplastic polyamide copolymer into the form of particles,
20 wherein the particles comprise a particle distribution D90 of 100 μm or less, typically 65 μm or less, more typically 50 μm or less.

The polyamide copolymer, or copolyamide, according to the present disclosure may be prepared according to any method known to a person of ordinary skilled in the art, notably by reacting the various monomers described herein to produce the copolyamide of the invention. For example, the copolyamides may be made from carboxylic acids and amines, from esters and amines, or from acid halides and amines.

For example, in a suitable method, the monomers are dissolved in water in a reactor at a temperature below 100° C. to form a salt mix. The salt solution is then concentrated by distillation under atmospheric pressure or low pressure, followed by further heating to carry out the polycondensation under pressure, while water added and/or formed in the media is continuously removed by distillation. The pressure is then lowered to complete the polycondensation at a temperature above the melting of the polymer before opening the reactor to obtain the polymer in a molten state. The molten polymer can then be processed using an extruder to form pellets to be further processed into particles.

In certain embodiments, the thermoplastic copolyamide is made by reacting (a) at least one C₆-C₁₆ cycloaliphatic diamine, typically at least one C₈-C₁₂ cycloaliphatic diamine, (b) at least one C₆-C₁₀ linear or branched aliphatic diamine, typically at least one C₆-C₈ linear or branched aliphatic diamine, and (c) at least one C₁₀-C₁₄ linear or branched aliphatic dicarboxylic acid, typically at least one C₁₀-C₁₂ linear or branched aliphatic dicarboxylic acid to create the thermoplastic polyamide copolymer.

In certain embodiments, the thermoplastic copolyamide is made by reacting (a) at least one C₈-C₁₂ cycloaliphatic diamine, and (b) at least one C₆-C₁₀ linear or branched aliphatic diamine, typically at least one C₆-C₈ linear or branched aliphatic diamine, and (c) at least one C₁₀-C₁₄ linear or branched aliphatic dicarboxylic acid, typically at least one C₁₀-C₁₂ linear or branched aliphatic dicarboxylic acid in a reactor to create the thermoplastic polyamide copolymer.

In an embodiment, the thermoplastic copolyamide is made by reacting (a) at least isophorone diamine, and (b) at least hexamethylene diamine, and (c) at least sebacic acid in a reactor to produce the thermoplastic copolyamide.

In some embodiments, the thermoplastic copolyamide is made by reacting (a′) at least one C₆-C₁₆ cycloaliphatic diamine, typically at least one C₈-C₁₂ cycloaliphatic diamine, (b′) at least one dicarboxylic acid, and (c′) at least one C₆-C₁₅ amino acid or C₆-C₁₅ lactam.

The thermoplastic polyamide copolymer, typically in the form of pellets, is processed into particles that comprise a particle distribution D90 of 100 μm or less, typically 65 μm or less, more typically 50 μm or less. Any means known to those of ordinary skill in the art may be used. Suitable methods include, but are not limited to, chopping, grinding, milling, melt emulsification, and the like.

For example, the pellets may be ground at low temperatures, generally ranging from dry ice temperatures to liquid nitrogen temperatures. This type of grinding process is generally known as cryogenic grinding or cryogenic milling. In order to reach such low temperatures, pellets of the thermoplastic polyamide copolymer can be exposed to liquid nitrogen, liquid carbon dioxide, or both. The pellets can then be ground or milled to produce thermoplastic polyamide copolymer particles having a particle distribution D90 of 100 μm or less, typically 65 μm or less, more typically 50 μm or less.

In an embodiment, the thermoplastic polyamide copolymer particles are made by a melt emulsification process. In such a process, the thermoplastic polyamide copolymer is dispersed at a temperature above its melting in an emulsifying system to form the thermoplastic polyamide copolymer particles having a particle distribution D90 of 100 μm or less, typically 65 μm or less, more typically 50 μm or less. The thermoplastic polyamide copolymer can be dispersed in a molten state in the emulsifying system in various ways. In certain embodiments, the thermoplastic polyamide copolymer can be dispersed in the emulsifying system by adding both the thermoplastic polyamide copolymer and the emulsifying system to an extruder or a reactor equipped with a stirrer, at a temperature above their melting and then forming a dispersion comprising the thermoplastic polyamide copolymer and the emulsifying system in the extruder or in the reactor. In such embodiments, the thermoplastic polyamide copolymer particles can be formed from the thermoplastic polyamide copolymer as part of the dispersion. Once the dispersion comprises both the emulsifying system and the thermoplastic polyamide copolymer particles having a particle distribution D90 of 100 μm or less, typically 65 μm or less, more typically 50 μm or less, then the thermoplastic polyamide copolymer particles can be separated from the dispersion. In this respect, the thermoplastic polyamide copolymer particles can be separated from the dispersion by washing the dispersion having both the thermoplastic polyamide copolymer particles and the emulsifying system. In some embodiments, the dispersion can be washed with any liquid solvent and/or aqueous medium in which the emulsifying system is fully or partially soluble. Washing may be conducted more than once. In some embodiments, the dispersion having both the thermoplastic polyamide copolymer particles and the emulsifying system may be washed 2 to 7 times, typically 3 to 7 times, more typically 5 to 7 times. After the thermoplastic polyamide copolymer particles are separated from the dispersion, including substantially removing the emulsifying system, the particles are dried, typically by heating in the range of 80-90° C., more typically 90° C. After drying, the thermoplastic copolyamide particles typically have a moisture content of 0.1 to 0.4 wt % of water. The thermoplastic copolyamide particles may be stored for a time after which uptake of water leads to particles having high moisture content (HMC), typically about 2 wt % of water.

The emulsifying system used in the melt emulsification process can be formed from at least one emulsifier. In certain preferred embodiments, the emulsifying system can have at least one emulsifier selected from poly(ethylene oxide) (“PEO”) polymers, poly(propylene oxide) (“PPO”) polymers, PEO/PPO copolymers, including but not limited to PEO/PPO block and random copolymers, poly(ethylene terephthalate) (“PET”) polymers, and PEO/PET block and random copolymers. Additionally, the emulsifying system can have at least one linked and/or grafted emulsifier. For example, the at least one emulsifier in the emulsifying system can be at least one PEO/PPO copolymer linked with a diamine group having a C₂-C₆ aliphatic group, and typically the diamine group has a C₂-C₄ aliphatic group.

The particles described herein are characterized by a particle size distribution, which is indicated by a D90 or D(v, 0.9) value, a D50 or D(v, 0.5) value, and/or D10 or D(v, 0.1) value. As used herein, the particle size distribution refers to volume distribution, unless otherwise stated. The particle size distribution may be measured using any method or instrument known to those of ordinary skill in the art. For example, instruments using laser diffraction technology, such as a MasterSizer 2000 or 3000 available from Malvern, may be used according to the manufacturers' instructions or known methods. As would be understood by a person of ordinary skill in the art, D90 or D(v, 0.9) is the size of particle below which 90% of the sample lies. D50 or D(v, 0.5) is the size in microns at which 50% of the sample is smaller and 50% is larger. Similarly, D10 or D(v, 0.1) is the size of particle below which 10% of the sample lies. Any combination of D10, D50, and D90 ranges described herein is contemplated by the present disclosure.

In an embodiment, processing the thermoplastic polyamide copolymer into the form of particles having a particle distribution D90 of 100 μm or less, typically 65 μm or less, more typically 50 μm or less, is achieved by melt emulsification.

With respect to size, the particles have a particle size distribution D90 of 100 μm or less, typically 65 μm or less, more typically 50 μm or less, most typically 30 μm or less.

In other embodiments, the thermoplastic polyamide copolymer particles can have a particle distribution D50 of 45 μm or less, typically 25 μm or less, more typically 20 μm or less.

Additionally, the thermoplastic polyamide copolymer particles can have a particle distribution D10 of at least 1 μm, typically at least 2.5 μm, more typically at least 5 μm.

In certain embodiments, the thermoplastic polyamide copolymer particles can have a particle distribution range of D10 to D90 ranging from at least 5 μm to 50 μm or less, typically ranging from at least 5 μm to 30 μm or less.

The melting and re-crystallization transitions of the particles of the present invention can be observed using modulated differential scanning calorimetry (“MDSC”). MDSC is a modification of conventional DSC with the added ability to separate the sample heat flow resulting from time dependent processes, such as, e.g., crystallization, from sample heat flow resulting from time independent processes, such as, e.g., sample heat flow rate due to the sample heat capacity (see, e.g., Daley, Robert L., Thermochimica Acta, Volume 402, Issues 1-2, 3 Jun. 2003, Pages 91-98, New modulated DSC measurement technique).

The particles of the present invention comprise a polyamide copolymer that exhibits, as determined by MDSC during the first heating of a sample of such polyamide copolymer, an endothermic melting enthalpy (“ΔHₘ”) curve occurring above 0° C. on the MDSC reversing heat flow signal and an exothermic crystallization enthalpy (“ΔH_{c}”) occurring above 0° C. on the MDSC non-reversing signal. The crystallization temperature at the peak of the ΔH_{c} curve (“T_{c}”) is lower than the melt temperature at the peak of the ΔHₘ curve (“Tₘ”) and the difference between the T_{c} and Tₘ of such polyamide copolymer is less than or equal to 30° C., more typically less than or equal to 20° C., and even more typically less than or equal to 10° C.

The particles of the present invention are generally spherical or oblong in shape, which is in contrast to materials that may be shaped as fibers or have irregular shapes. In some embodiments, due to the copolyamide being semi-crystalline, the particles can also have facets corresponding to the underlying crystalline lattice of the crystalline phase of the particles.

The thermoplastic polyamide particles of the present invention can be used to improve the properties of variety of composite materials. For example, the thermoplastic polyamide particles of the present invention can be used to toughen FRP composites and/or reduce the occurrence of microcracking in such composites useful for a variety of applications, including the aerospace, automotive, marine, industrial, and infrastructure/building fields.

Thus, in the third aspect, the present disclosure relates to a composite material comprising: the collection of thermoplastic copolyamide particles described herein or the thermoplastic copolyamide particles made according to the process described herein; reinforcing fibers, and a matrix resin.

As used herein, the term “fiber” has its ordinary meaning as known to those skilled in the art and may include one or more fibrous materials adapted for the reinforcement of composites, which may take the form of any of particles, flakes, whiskers, short fibers, continuous fibers, sheets, plies, and combinations thereof.

Prepregs are used when making FRP composite articles, especially for certain fields such as aerospace, automotive, marine, industrial, and infrastructure/building applications. Generally, prepregs have reinforcing fibers impregnated with a given matrix resin, such as thermoset polymers or thermoplastic polymers. The reinforcing fibers in a prepreg can generally have a variety of forms, and can be oriented in various ways to form different structures, including weaves, fabrics, veils, and other structures. In order to form a prepreg layup, multiple prepregs can be layered, such that when the prepregs are heated and then finished into the final composite article, the composite article has internal layers formed from the reinforcing fibers and matrix resin. In an embodiment, the composite material is in the form of a prepreg.

In this respect, the interlaminar regions in the composite article, which are the regions between the layers of reinforcing fibers, are formed from the matrix resin. Specifically, when the prepregs are heated and finished into the final composite article, the prepregs are laminated together by the matrix resin, which also forms the interlaminar regions between the layers of reinforcing fibers in the composite article. The thermoplastic polyamide particles of the present invention can be used to toughen the final composite articles and/or reduce microcracking in the composite articles by adding the particles into the interlaminar region. The thermoplastic copolyamide particles can be dispersed in the matrix resin in the interlaminar region in the composite material. When the composite material is made into the final composite article, the matrix resin and the thermoplastic copolyamide particles can bond to prevent delamination and fracturing within the interlaminar region.

Various types of prepregs can be used in the instant invention. As used herein, the term “prepreg” refers to a layer of reinforcing fibers that has been impregnated or infused with a matrix resin. The term “impregnate,” “infuse,” and similar terms as used in this disclosure with respect to a prepreg refers to contacting the reinforcing fibers with the matrix resin such that the reinforcing fibers are partially or fully coated or encapsulated with the matrix resin.

In general, the prepreg can have 25 wt. % to 50 wt. %, typically 30 wt. % to 40 wt. %, and most typically 32 wt. % to 38 wt. % of the matrix resin, based on the total wt. % of the prepreg. Additionally, in general, the prepreg can have 50 wt. % to 75 wt. %, typically 60 wt. % to 70 wt. %, and most typically 62 wt. % to 68 wt. % of the reinforcing fibers, based on the total wt. % of the prepreg.

Reinforcing fibers in the prepregs that are useful for the instant invention can be in various shapes and forms, and can be oriented in various ways. For example, the reinforcing fibers can be chopped fibers, continuous fibers, filaments, tows, bundles, and combinations thereof. Additionally, the reinforcing fibers can be unidirectional oriented (i.e., aligned in one direction) or multi-directional oriented (i.e., aligned in different directions), and the reinforcing fibers can form various structures, including but not limited to a sheet, ply, weave, fabric, non-woven, woven, knitted, stitched, wound, and braided structure, as well as swirl mat, veil, felt mat, and chopped mat structures. Woven structures having the reinforcing fibers may comprise a plurality of woven tows, in which each tow is composed of a plurality of filaments, including but not limited to thousands of filaments. In certain embodiments, the reinforcing fibers can form a structure such that the reinforcing fiber density is 100 gsm to 1000 gsm, typically 200 gsm to 500 gsm, and even more typically 250 gsm to 450 gsm. In further embodiments, the tows may be held in position by cross-tow stitches, weft-insertion knitting stitches, or a small amount of resin binder, such as a thermoplastic or thermoset resin.

Reinforcing fibers in the prepregs useful for the instant invention can be made from a variety of materials to form the corresponding fibers including, but not limited to, glass (to form glass fibers), carbon, graphite, aramid, polyamide, high-modulus polyethylene (PE), polyester, poly-p-phenylene-benzoxazole (PBO), boron, quartz, basalt, ceramic, organic synthetic materials, such as Kevlar®, ceramic, metals, including copper, thermoplastic polymer, and combinations thereof. In certain preferred embodiments, the reinforcing fibers are glass fibers, carbon fibers, thermoplastic polymer fibers, glass fiber fabric, carbon fiber fabric, and combinations thereof. Further, the glass fibers can be any glass fibers, including but not limited to glass fibers selected from Electrical or E-glass fibers, A-glass fibers, C-glass fibers, E-CR-glass fibers, D-glass fibers, R-glass fibers, S-glass fibers, or combinations thereof. The carbon fibers can also be any carbon fibers, including but not limited to carbon fibers formed from a polyacrylonitrile (PAN) polymer, pitched-based carbon fibers, and combinations thereof.

In certain embodiments, such as for making high-strength composite materials, the reinforcing fibers can typically have a tensile strength of greater than 3500 MPa (per ASTM D4018 test method).

The matrix resins useful for the instant invention can be selected from a variety of polymeric resins. For instance, the matrix resin can be a thermoplastic resin, a thermoset resin, or combinations thereof. Additionally, the matrix resin can have more than one thermoplastic resin, more than one thermoset resin, or combinations of more than one thermoplastic and thermoset resins.

In certain embodiments, the matrix resin can be a thermoplastic resin selected from polyamides, polyphthalamides, poly(aryl ether sulfone)s, including but not limited to polysulfone, polyethersulfone, polyetherethersulfone, polyethersulfone/polyetherethersulfone copolymers, and polyphenylsulfone, poly(aryl ether ketone)s, including but not limited to polyether ketone, polyether ether ketone, poly ether ketone ketone, polyetherimides, polyimides, polyamide imides, polyphenylene sulfides, polycarbonates, fluoropolymers, including polyvinylidene fluoride, and combinations thereof. In certain preferred embodiments, the thermoplastic matrix resin can be a thermoplastic resin selected from polyamides, poly(aryl ether sulfone)s, including but not limited to polysulfone, polyethersulfone, polyethersulfone/polyetherethersulfone copolymers, and polyphenylsulfone, poly(aryl ether ketone)s, including but not limited to polyether ketone, polyether ether ketone, poly ether ketone ketone, polyphenylene sulfides, and combinations thereof.

In other embodiments, the matrix resin can be a thermoset resin selected from epoxies, phenolics, phenols, cyanate esters, bismaleimides, benzoxazines, polybenzoxazines, polybenzoxazones, and combinations thereof and precursors thereof. In certain preferred embodiments, the matrix resin can be a multifunctional epoxy resins (or polyepoxides) having a plurality of epoxide functional groups per molecule. The polyepoxides can be saturated, unsaturated, cyclic, acyclic, aliphatic, aromatic, or heterocyclic. Examples of polyepoxides include, but are not limited to, polyglycidyl ethers, which are prepared by a reaction of epichlorohydrin or epibromohydrin with a polyphenol in the presence of alkali. Examples of useful polyphenols for making polyglycidyl ethers include, but are not limited to, resorcinol, pyrocatechol, hydroquinone, bisphenol A (bis(4-hydroxyphenyl)-2,2-propane), bisphenol F (bis(4-hydroxyphenyl)methane), fluorine 4,4′-dihydroxy benzophenone, bisphenol Z (4,4′-cyclohexylidenebisphenol) and 1,5-hyroxynaphthalene. Other suitable polyphenols for making polyglycidyl ethers are the known condensation products of phenol and formaldehyde or acetaldehyde of the novolac resin-type.

Non-limiting examples of suitable epoxy resins include diglycidyl ethers of bisphenol A or bisphenol F, e.g., EPON™ 828 (liquid epoxy resin), D.E.R. 331, D.E.R. 661 (solid epoxy resins) available from Dow Chemical Co.; and trifunctional epoxy resins, including triglycidyl ethers of aminophenol, e.g., ARALDITE® MY 0510, MY 0500, MY 0600, MY 0610 from Huntsman Corp., and combinations thereof. Additional examples include, but are not limited to, phenol-based novolac epoxy resins, commercially available as D.E.N.™ 428, D.E.N.™ 431, D.E.N.™ 438, D.E.N.™ 439, and D.E.N.™ 485 from Dow Chemical Co; cresol-based novolac epoxy resins commercially available as ECN 1235, ECN 1273, and ECN 1299 from Ciba-Geigy Corp.; and hydrocarbon novolac epoxy resins commercially available as TACTIX® 71756, TACTIX® 556, and TACTIX® 756 from Huntsman Corp., and combinations thereof.

The curing agents useful for curing the thermoset resins may be selected from known curing agents including, for example, aromatic or aliphatic amines, or guanidine derivatives. In certain preferred embodiments, the curing agent can be an aromatic amine, and typically an aromatic amine having at least two amino groups per molecule, and particularly preferable are diaminodiphenyl sulphones, for instance where the amino groups are in the meta- or in the para-positions with respect to the sulphone group. Particular non-limiting examples are 3,3′- and 4,4′-diaminodiphenylsulphone (DDS); methylenedianiline; bis(4-amino-3,5-dimethylphenyl)-1,4-diisopropylbenzene; bis(4-aminophenyl)-1,4 diisopropylbenzene; 4,4′methylenebis-(2,6-diethyl)-aniline (MDEA from Lonza); 4,4′methylenebis-(3-chloro, 2,6-diethyl)-aniline (MCDEA from Lonza); 4,4′methylenebis-(2,6-diisopropyl)-aniline (M-DIPA from Lonza); 3,5-diethyl toluene-2,4/2,6-diamine (D-ETDA 80 from Lonza); 4,4′methylenebis-(2-isopropyl-6-methyl)-aniline (M-MIPA from Lonza); 4-chlorophenyl-N,N-dimethyl-urea (e.g., Monuron); 3,4-dichlorophenyl-N,N-dimethyl-urea (e.g., Diuron™), dicyanodiamide (e.g., Amicure® CG 1200 from Pacific Anchor Chemical), and combinations thereof.

In other embodiments, the curing agents can be anhydrides, and in particular polycarboxylic anhydrides, such as nadic anhydride, methylnadic anhydride, phthalic anhydride, tetrahydrophthalic anhydride, hexahydrophthalic anhydride, methyltetrahydrophthalic anhydride, endomethylenetetrahydrophtalic anhydride, trimellitic anhydride, and combinations thereof.

The thermoplastic polyamide particles described herein may be incorporated into the composite material using methods known to those of ordinary skill in the art. In a suitable method, the particles are added to the matrix resin by blending or dispersing the particles in the matrix resin. In such embodiments, when the prepregs are layered or stacked to form the prepreg layup, the thermoplastic polyamide particles end up in the interlaminar regions between the layers of reinforcing fibers in the final composite article.

In one embodiment, the prepreg comprises, based on the total weight of the prepreg:
from 25 wt % to 50 wt %, more typically from 30 wt % to 40 wt %, and even more typically from 32 wt % to 38 wt % of matrix resin,
from 50 wt % to 75 wt %, more typically from 60 wt % to 70 wt %, and even more typically from 62 wt % to 68 wt % of reinforcing fibers, and
from 0 wt % to 25 wt %, more typically from 5 wt % to 20 wt %, and even more typically from 10 wt % to 15 wt % of polyamide copolymer particles.

In the fourth aspect, the present disclosure relates to a composite article produced from the composite material described herein. The composite article is generally produced by curing the composite material, typically by heating the composite material.

In some embodiments, the composite articles are made by placing or stacking multiple prepregs together to form a stack or prepreg layup, which is then cured, typically by heating using any means known to those of ordinary skill in the art. The prepregs within the prepreg layup may be positioned or layered in a selected orientation with respect to one another, based on the orientation of the reinforcing fibers or other reinforcement structures within the prepregs and/or prepreg layup. For instance, the prepregs within the prepreg layup may be placed or stacked in the same general direction (e.g., at 0°) to one another, or the prepregs within the prepreg layup may be placed or stacked in various directions to one another (e.g., ±45°, 90°, etc.). The placement and direction of the prepregs within the prepreg layup can be oriented based on the desired strength and properties of the resulting composite article. As a non-limiting example, stacking or layering the prepregs within the prepreg layup in the same general direction may provide a composite article that is very strong in some directions (i.e., against the flexion of the reinforcements) while relatively weak in other directions (i.e., in the same direction as, and without flexion of, the reinforcements). Alternatively, stacking or layering the prepregs within the prepreg layup in various orientations, such as alternating the direction of the prepregs at ±45°, may provide a composite article that is generally strong in all directions.

The composite articles of the present disclosure may be characterized by their mechanical properties, including Compression After low-velocity Impact (CAI; determined according to BSS 7260, Type II, Class 2 at room temperature, units KSI), Open Hole Tension (OHT*; determined according to D6-83079-62, Type 1 at room temperature, units KSI), Open Hole Tension at −75° F. (OHT* −75° F., determined according to D6-83079-62, Type 1 at −75° F., units KSI), and Open Hole Compression (OHC, determined according to D6-83079-71, type 2 , CL11 at room temperature, units KSI).

In an embodiment, the composite material has a CAI of at least 35, at least 40, at least 41, at least 45, or at least 47 KSI.

In another embodiment, the composite material has an OHT* of at least 50, at least 60, at least 67, at least 69, or at least 70 KSI.

In yet another embodiment, the composite material has an OHT* −75° F. of at least 63, at least 65, or at least 66 KSI.

In an embodiment, the composite material has an OHC at least 43, at least 44, at or 20 at least 46 KSI.

As will be further illustrated by the following non-limiting examples, the properties of the inventive thermoplastic copolyamide particles provide comparable or better toughening to composite articles than known copolyamides while providing significant and unexpected reduction in microcracking in such composite articles.

### EXAMPLES

### Example 1. Synthesis of Inventive Copolyamides

Thermoplastic polyamide copolymers having a recurring unit (RPA1) formed from the polycondensation of hexamethylene diamine and sebacic acid and another recurring unit (RPA2) formed from the polycondensation of isophorone diamine and sebacic acid were synthesized. The thermoplastic polyamide copolymers were made according to the following general procedure and the amounts of isophorone diamine, 1,6-diaminohexane, and 1,10-decanedioic acid were varied to obtain thermoplastic polyamide copolymers in which the relative molar concentration of recurring unit (RPA1) to recurring unit (RPA2) was 90/10, 80/20, and 75/25.

1,10-decanedioic acid (a.k.a., sebacic acid, available from Arkema), a 59.6% solution of 1,6-diaminohexane (a.k.a., hexamethylene diamine, available from Domo), isophorone diamine (available from Merck), demineralized water, and sodium hypophosphate solution (4% of phosphorous compound), and antifoam (Silcolapse 5020 available from Elkem) were added to a stainless-steel autoclave. The autoclave atmosphere was purged 4 times with nitrogen and then agitated. The temperature was progressively increased up to 103° C. to obtain a homogeneous salt solution, which was subsequently concentrated up to 65% by distillation. The temperature was then increased while continually stirring until the pressure reached 3.5 bar (144° C.) to continue the water distillation up to a concentration of 75% (pressure release valve fixed at 3.5 bars). The reactor was then heated up rapidly until vapor pressure reached 18.5 bars. From that point, temperature was progressively increased and water is released through the pressure control valve to maintain 18.5 bars until temperature of the medium reached 250° C. Subsequently, the reactor was decompressed to a vacuum of 750 mbars accompanied by heating of the reaction medium to 272° C. The reaction mixture was then maintained at 0.750 mbar, 272° C. for 30 min. At the end of the polymerization reaction, the polymer melt is poured from the reactor (under nitrogen pressure) and then pelletized.

### Example 2. Melt Emulsification of Copolyamides

The pellets of thermoplastic polyamide copolymer made according to Example 1 were formed into particles using the following general melt emulsification process a Clextral corotative twin screw extruder (D=32 mm; L/D=40). Emulsifiers that were used were 1) ethylene oxide/propylene oxide block copolymer (Synperonic T908; available from Croda), 2) non-ionic difunctional block PEO/PPO copolymer surfactant having terminal primary hydroxyl groups (Pluronic® F-108; available from BASF), and polyethylene glycol, Mw˜20000 g/mol (PEG 20000, available from Clariant).

The polymer pellets made in Example 1 and the various emulsifiers (50/50 wt ratio) were both added in the 1st zone of the extruder and an open barrel was used in zone no. 9 for degassing with 10 heating zones used. The first one was heated at 25° C., the second one was heated at 50° C., the third at 200° C. and the fourth at 250° C. 250° C. was applied up to the last zone. The screw speed applied was about 600 rpm. The throughput was 10 kg/hr, with 5 kg/hr per feeder. The resulting melted particles surrounded by melted emulsifier were collected into a flask containing cold water to provide a slurry containing the thermoplastic polyamide copolymer particles. The particles were recovered by centrifugation. Washing and centrifugation steps (0, 5, or 7 times) were applied to remove the emulsifier. Particles were then dried at 90° C.

Polyamide PA610 polymer pellets (available from Domo as Stabamid®) were melt emulsified in the same manner and used as a reference. The particles made are summarized in Table 1 below.

TABLE 1

| Example | [RPA1]/[RPA2] | Surfactant | Washed | HMC |
|---|---|---|---|---|
| A* | — | Synperonic | no | no |
| B | 75/25 | Synperonic | no | no |
| C | 75/25 | PEG 20k | 5x | no |
| D | 75/25 | PEG 20k | 5x | yes |
| E | 75/25 | PEG 20K | 7x | no |
| F | 80/20 | Synperonic | no | no |
| G | 80/20 | PEG 20K | 5x | no |
| H | 80/20 | PEG 20K | 5x | yes |
| I | 80/20 | PEG 20K | 7x | no |
| J | 90/10 | Pluronic | 5x | no |
| K | 90/10^{†} | PEG 20K | 5x | no |
| L | 90/10^{‡} | PEG 20K | 5x | no |
| M | 90/10 | Pluronic | 7x | yes |

*PA610 polymer (available from Domo as Stabamid ®)
^{†}Mₙ~14000 g/mol
^{‡}Mₙ~10000 g/mol

The T_{g} of the particles were analyzed using differential scanning calorimetry (DSC) with a Perkin Elmer 8000 instrument. For each measurement, approximately 10 mg of sample were placed in an aluminium cap that was then closed (not hermetically) with a lid. The sample was run under nitrogen flow (50 ml/min). After a stabilization step of 1 min at 40° C., a first heating ramp was applied at 10° C./min up to 270° C. followed by a stabilization step of 5 min at 270° C. A cooling ramp was then applied at 10° C./min up to 0° C. After 5 min at 0° C., a second heating ramp was applied at 10° C./min up to 270° C. T_{g} was measured on the signal obtained during this second heating ramp at 10° C./min (Midpoint).

The Tₘ and T_{c} of the inventive particles were measured by Modulated Differential scanning calorimetry (MDSC) with a Q2000 machine available from TA Instrument. For each measurement, approximately 10 mg of sample were added to an aluminium cap that was then closed (not hermetically) with a lid, then the sample was dried in the closed cap in a vacuum (<5 mbars) oven for 16 h at 90° C. The accurate weight was then measured after the drying step.

The MDSC measurements were run using the Heat only mode under nitrogen flow (50 ml/min) immediately after the drying step or after being stored in a sealed bag to avoid moisture uptake. Measurement was done on a first heating ramp after an isothermal step of 5 min, applying the following conditions: equilibration at 35° C., modulation of +/−0.53° C. every 40 s, isothermal standing for 5 min, then application of a heating ramp of 5° C./min to 300° C.

Signals of interest are the reversing heat flow and the non reversing heat flow. Crystallization behavior was observed as an exothermic peak. The melting was observed as an endothermic peak. The values of Tₘ and T_{c} were taken as the values at the maximum of the respective peaks.

The particle size distributions of the particles were determined by a wet method using a Malvern Mastersizer 3000 equipped with Hydro LV dispersion unit. A pre-dilution in deionized water was employed to disperse the particles to obtain a homogenous suspension. In a 60 ml glass bottle, about 2 g of the particles and 58 g of deionized water were combined and the resulting suspension was agitated using a magnetic stirrer for 30 min. The suspension obtained was sonicated in an ultrasonic bath for 30 min to complete the particle dispersion in water. With a pipette, approximately 1.5 ml of suspension was added to the Hydro LV unit, which circulated the sample through the wet cell of the Mastersizer 3000.

The properties of the particles made are summarized in Table 2 below.

TABLE 2

| | Particle size | | | | |
|---|---|---|---|---|---|
| | distribution | | | | Tₘ − |
| | (D10/D50/D90) | T_{g} | Tₘ | T_{c} | T_{c} |
| Example | (nm) | (° C.) | (° C.) | (° C.) | (° C.) |
| A | 10/28/58 | | 221 | 219 | 2 |
| B | 9/32/70 | | 197 | 195 | 2 |
| C | 5/12/25 | 67 | 196 | 189 | 7 |
| D | 5/12/25 | | | | |
| E | 5/11/22 | 69 | | | |
| F | 7/27/70 | | 203 | 197 | 7 |
| G | 5/14/29 | 61 | 205 | 199 | 6 |
| H | 5/14/29 | | | | |
| I | 5/14/29 | 66 | | | |
| J | 7/27/57 | | 213 | 212 | 1 |
| K | 8/14/37 | | 213 | 212 | 1 |
| L | 9/15/25 | 56 | 214 | 211 | 3 |
| M | 8/25/47 | | | | |

As shown in Table 2, the particles obtained by using PEG 20 k as emulsifier were significantly smaller than those obtained by using either Synperonic or Pluronic.

### Example 3. Production of Composite Articles

Composite test panels were prepared by adding the thermoplastic polyamide copolymer particles made according to Example 2 to an epoxy matrix resin and curing agent to form a resin mixture. The mixture of the thermoplastic polyamide copolymer particles, epoxy matrix resin, and curing agent was added to a mixing vessel and heated. Once fully mixed, the mixture of the thermoplastic polyamide copolymer particles and epoxy matrix resin was then layered onto coated silicone release paper using a roll coater to produce a film. Prepregs, each having the same type of thermoplastic copolyamide particles, were made whereby reinforcing fiber tows were spread and laminated with two layers of the film. The resulting prepregs were plied (24 plies at (+45/0/−45/90)3 s) to make 14″×14″ panels, which were cured in an autoclave at the desired temperature and pressure. The cured panels were machined into coupons (Six 5″×3″ coupons from each panel) for thermocycling and microcrack analysis.

### Example 4. Thermocycling and Microcrack Analysis of Composites

To evaluate the composite panels made according to Example 3, the coupons from the same panel were subjected to thermocycling 2000 times in five 400-cycle blocks. Before each 400-cycle block, the coupons were preconditioned for 12 (±0.5 hr) hours at 120° F. (±5° F.) and 95% relative humidity (±5%), followed by 1 hour at −65° F. After conditioning, the coupons were immediately transferred to a thermocycling chamber to undergo 400 cycles of 3 minutes at 160° F. (±5° F.) and 3 minutes at −65° F. (±5° F.). One coupon was removed at 400, 800, 1200, 1600, and 2000 cycles. A 1″×2″ section of each coupon was machined from the top right corner of the coupon and then observed under optical microscopy to record the total number of confirmed microcracks in this area. One coupon was not subjected to thermocycling and used as a reference. Results of the microcracking analysis of certain composite panels are summarized in Table 3 below.

TABLE 3

Cycles

| Example | 0 | 400 | 800 | 1200 | 1600 | 2000 |
|---|---|---|---|---|---|---|
| A | 0 | 31 | 42 | >50 | >50 | >50 |
| C | 0 | 1 | 0 | 2 | 1 | 0 |
| D | 0 | 0 | 0 | 3 | 1 | 7 |
| E | 0 | 2 | 0 | 0 | 3 | 5 |
| G | 6 | 3 | 2 | 6 | — | 6 |
| I | 0 | 3 | 3 | 4 | — | 11 |
| J | 0 | 0 | 8 | 21 | 46 | >50 |

As shown in Table 3, the coupons having the inventive thermoplastic copolyamide particles (Ex. C, D, E, G, I, and J) all exhibited lower microcracking than the one made with commercial PA610 polyamide (Ex. A). However, the coupons made from thermoplastic copolyamide particles in which [RPA1]/[RPA2] was 80/20 (Ex. G and I) or 75/25 (Ex. C, D, and E) performed much better (i.e., exhibited less microcracking) than those in which [RPA1]/[RPA2] was 90/10 (Ex. J). Without being bound by theory, it is believed that incorporation of certain amounts of the cycloaliphatic diamine, as exemplified by isophorone diamine, as well as the particle size distribution may contribute to the reduction of microcracking of composite articles containing them.

### Example 5. Use of Inventive Particles as Toughening Agents in Composites

The effectiveness of the thermoplastic copolyamide particles described herein as toughening agents was evaluated in a number of composite panels made according to Example 3. Several properties were measured, including Compression after low-velocity Impact (CAI; determined according to BSS 7260, Type II, Class 2 at room temperature, units KSI), Open Hole Tension (OHT*; determined according to D6-83079-62, Type 1 at room temperature, units KSI), and Open Hole Tension at −75° F. (OHT* −75° F., determined according to D6-83079-62, Type 1 at −75° F., units KSI) as indicators of toughening. The results are summarized in Table 4 below.

TABLE 4

| | CAI | OHT* | OHT* −75° F. | OHC |
|---|---|---|---|---|
| Example | (KSI) | (KSI) | (KSI) | (KSI) |
| A | 42.79 | 69.51 | 64.46 | 42.78 |
| B | 47.21 | 74.12 | 68.06 | 44.12 |
| C | 43.90 | 72.70 | 69.60 | 43.86 |
| E | 43.60 | 71.20 | 69.40 | 43.73 |
| F | 45.46 | 72.28 | 66.77 | 46.22 |
| H | 46.10 | — | — | 46.47 |
| J | 44.53 | 74.62 | 69.57 | 46.11 |
| K | 45.38 | 67.77 | 65.48 | 43.65 |
| L | 41.43 | 67.95 | 63.82 | 44.73 |
| M | 43.29 | 72.46 | 65.95 | 46.16 |

As shown in Table 4, the CAI values of the composites made with the inventive thermoplastic copolyamide particles were generally higher than the reference composite (Ex. A), with the exception of Example L, which exhibited slightly lower CAI values compared to Example A, but higher OHC than that of reference Example A.

On the basis of the results summarized in Tables 3 and 4, it can be seen that the inventive thermoplastic copolyamide particles described herein are effective for toughening composite articles and/or reducing microcracking in such articles.

The present subject matter being thus described, it will be apparent that the same may be modified or varied in many ways. Such modifications and variations are not to be regarded as a departure from the spirit and scope of the present subject matter, and all such modifications and variations are intended to be included within the scope of the following claims.

1. A collection of thermoplastic copolyamide particles comprising:
a particle distribution D90 of 100 μm or less, and wherein the copolyamide comprises recurring units RPA1 and RPA2 or RPA3 and RPA2, wherein RPA1 is represented by the structure 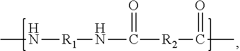
RPA2 is represented by the structure 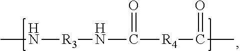
and
RPA3 is represented by the structure 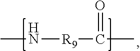
wherein
R₁ is a C₂-C₁₈ aliphatic group;
R₂ is a C₂-C₁₆ aliphatic group;
R₃ is selected from the group consisting of C₂-C₁₈ alkylene groups, C₆-C₁₈ arylene groups, and C₅-C₁₈ cycloaliphatic groups;
R₄ is selected from the group consisting of C₂-C₁₆ alkylene groups, C₆-C₁₈ arylene groups and C₅-C₁₈ cycloaliphatic groups; and
R₉ is a C₅-C₁₄ alkylene;
wherein the collection of copolyamide particles comprises:
a glass transition temperature of no more than 100° C.; and
a melting enthalpy peak temperature and a crystallization enthalpy peak temperature, each as determined by modulated differential scanning calorimetry during the first heating of a sample of such dry copolymer, wherein melting enthalpy peak temperature is from 150 to 260° C. and the difference between the crystallization enthalpy peak temperature and the melting enthalpy peak temperature is less than or equal to 30° C.

2. The collection of thermoplastic copolyamide particles of claim 1, wherein the particles comprise a particle distribution (D50) of 45 μm or less.

3. The collection of thermoplastic copolyamide particles according to claim 1, wherein the particles have a particle distribution (D10) of at least 1 μm.

4. The collection of thermoplastic copolyamide particles according to claim 1, wherein the particles comprise a particle distribution range of (D10) to D90 ranging from at least 5 μm to 50 μm.

5. The collection of thermoplastic copolyamide particles according to claim 1, wherein the copolyamide copolymer comprises recurring units of at least one polycondensation product of:
at least one C₆-C₁₆ cycloaliphatic diamine,
at least one C₆-C₁₀ linear or branched aliphatic diamine, and
at least one C₁₀-C₁₄ linear or branched aliphatic dicarboxylic acid; or
recurring units of at least one polycondensation product of:
at least one C₆-C₁₆ cycloaliphatic diamine,
at least one dicarboxylic acid, and
at least one C₆-C₁₅ amino acid or C₆-C₁₅ lactam.

6. The collection of thermoplastic copolyamide particles according to claim 1, wherein recurring unit RPA1 is formed from the polycondensation of hexamethylene diamine and sebacic acid and recurring unit RPA2 is formed from the polycondensation of isophorone diamine and sebacic acid.

7. The collection of thermoplastic copolyamide particles according to claim 1, wherein the copolyamide comprises poly(hexamethylene sebacamide) and poly(isophorone sebacamide).

8. The collection of thermoplastic copolyamide particles according to claim 1, wherein the copolyamide comprises recurring units RPA1 and RPA2, and the relative molar concentration of recurring unit RPA1 to recurring unit RPA2 is at least 60/40.

9. The collection of thermoplastic copolyamide particles according to claim 1, wherein the copolyamide comprises:
70-95 mol. % of repeat units of formula: 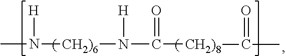
and
5-30 mol. % of repeat units of formula:

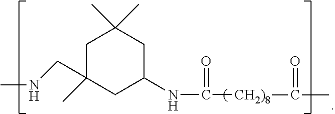

10. The collection of thermoplastic copolyamide particles according to claim 1, wherein the copolyamide comprises a melting temperature (“Tm”) of from 180° C. to 240° C.

11. The collection of thermoplastic copolyamide particles according to claim 1, wherein one of R₃ and R₄ is an alkyl group and R₃ and R₄ are not both alkyl groups.

12. The collection of thermoplastic copolyamide particles according to claim 1, wherein the copolyamide comprises recurring units RPA3 and RPA2.

13. A process for making thermoplastic copolyamide particles comprising a thermoplastic polyamide copolymer, the process comprising:
reacting (a) at least one C₆-C₁₆ cycloaliphatic diamine, (b) at least one C₆-C₁₀ linear or branched aliphatic diamine, and (c) at least one C₁₀-C₁₄ linear or branched aliphatic dicarboxylic acid, or
reacting (a′) at least one C₆-C₁₆ cycloaliphatic diamine, (b′) at least one dicarboxylic acid, and (c′) at least one C₆-C₁₅ amino acid or C₆-C₁₅ lactam to form the thermoplastic polyamide copolymer, and
processing the thermoplastic polyamide copolymer into the form of particles,
wherein the particles comprise a particle distribution D90 of 100 μm or less.

14. The process according to claim 13, wherein processing the thermoplastic polyamide copolymer into the form of particles comprises melt emulsification.

15. A composite material comprising:
the collection of thermoplastic copolyamide particles according to claim 1;
reinforcing fibers; and
a matrix resin.

16. The composite material according to claim 15, wherein the composite material is in the form of a prepreg.

17. A composite article produced from the composite material according to claim 15.

18. The composite article according to claim 17, wherein the composite article has a CAI of at least 35 KSI.

19. The composite article according to claim 17, wherein the composite article has an OHT* of at least 50 KSI.

20. The composite article according to claim 1, wherein the composite material has an OHT* −75° F. of at least 63 KSI.

21. The composite article according to claim 1, wherein the composite material has an OHC at least 43 KSI.
